(19) United States
(12) Patent Application Publication
(10) Pub. No.: US 2025/0251734 A1
(43) Pub. Date: Aug. 7, 2025

(54) CARPET DETECTING METHOD FOR ROBOT, ROBOT OBSTACLE AVOIDANCE METHOD, ROBOT, AND CHIP

(71) Applicant: AMICRO SEMICONDUCTOR CO., LTD., Zhuhai (CN)

(72) Inventors: Zhuobiao CHEN, Zhuhai (CN); Hewen ZHOU, Zhuhai (CN); Ming SUN, Zhuhai (CN); Huibao HUANG, Zhuhai (CN); Songzhou XU, Zhuhai (CN); Zexin CHEN, Zhuhai (CN)

(73) Assignee: AMICRO SEMICONDUCTOR CO., LTD., Zhuhai (CN)

(21) Appl. No.: 19/186,543

(22) Filed: Apr. 22, 2025

Related U.S. Application Data
(63) Continuation of application No. PCT/CN2023/135688, filed on Nov. 30, 2023.

(30) Foreign Application Priority Data
Dec. 16, 2022 (CN) 202211621392.4

(51) Int. Cl. G05D 1/622; A47L 11/40; G05D 1/242; G05D 105/10; G05D 107/40; G05D 111/10

(52) U.S. Cl. CPC G05D 1/622; A47L 11/4002; A47L 11/4011; A47L 11/4061; G05D 1/242; A47L 2201/04; A47L 2201/06; G05D 2105/10; G05D 2107/40; G05D 2111/10

(57) ABSTRACT

Disclosed are a carpet detection method for a robot, an obstacle avoidance method, a robot, and a chip. The carpet detection method includes: Step S1, in a case that the robot has detected an obstacle with an uneven contour, performing plane scanning based on data from a line laser sensor; and Step S2, in a case that an unevenness degree of the contour is within a preset range, determining that the obstacle is a carpet based on data obtained after the plane scanning.

### CROSS-REFERENCE TO RELATED APPLICATIONS

The present application is a continuation of International Application No. PCT/CN2023/135688, filed on Nov. 30, 2023, which claims priority to Chinese Patent Application No. 202211621392.4, filed on Dec. 16, 2022. The disclosures of the above-mentioned applications are hereby incorporated by reference in their entireties.

### TECHNICAL FIELD

The present disclosure relates to the field of intelligent robotics, in particular to a carpet detection method for a robot, an avoidance method, a robot, and a chip.

### BACKGROUND

With the rapid development of cleaning robots that have both sweeping and mopping functions, carpet identification has become increasingly crucial. A robot needs to know a position of a carpet to formulate distinct cleaning strategies. For instance, in a mopping mode, the robot should avoid the carpet to prevent the carpet from being wet, while in a sweeping mode, the robot should avoid the carpet whose height is greater than a preset value to prevent a main brush or a side brush from being stuck. Currently, mainstream methods for carpet identification include ultrasonic identification and main brush current identification. However, these methods have such problems as a slow response, a low identification rate, and being unable to detect a length of a carpet fiber.

### SUMMARY

An object of the present disclosure is to provide a carpet detection method for a robot, an obstacle avoidance method, a robot, and a chip. The technical solutions are provided as follows.

In one aspect, the present disclosure provides in some embodiments a carpet detection method for a robot, including: Step S1, in a case that the robot has detected an obstacle with an uneven contour, performing plane scanning based on data from a line laser sensor; and Step S2, in a case that an unevenness degree of the contour is within a preset range, determining that the obstacle is a carpet based on data obtained after the plane scanning.

In another aspect, the present disclosure provides in some embodiments an obstacle avoidance method, including the above-mentioned carpet detection method, and further including: Step S3, calculating a height of a carpet based on data from a line laser sensor, in a case that the height of the carpet is greater than or equal to a preset height, avoiding the carpet, and in a case that the height of the carpet is less than the preset height, proceeding to Step S4; and Step S4, in a case that the robot is operating on the carpet, identifying and calculating a height of a carpet fiber, and in a case that an obstacle with a height greater than the height of the carpet fiber, performing obstacle avoidance.

In yet another aspect, the present disclosure provides in some embodiments a robot for executing the above-mentioned obstacle avoidance method, including: a line laser sensor configured to generate a line laser to detect an object; an image sensor configured to obtain a line laser image projected by the line laser sensor onto a surface of the object; a point cloud height calculation module configured to calculate a height of a point cloud based on the line laser image obtained by the image sensor; a carpet identification module configured to determine whether an obstacle is a carpet based on the height of the point cloud; and an obstacle avoidance module configured to perform obstacle avoidance based on a height of the carpet and a height of a carpet fiber.

In still yet another aspect, the present disclosure provides in some embodiments a chip storing therein a computer program code. The computer program code is executed to implement the above-mentioned carpet detection method or obstacle avoidance method.

According to the carpet detection method in the embodiments of the present disclosure, the carpet is identified using the line laser sensor in real time. After an uneven contour is identified, the robot further performs the plane scanning, and determines that the obstacle is the carpet in a case that a height difference between the point clouds is within a preset range, so as to improve the identification accuracy. In addition, the detection is performed without a map and IMU data, resulting in a low computational burden and a rapid response. Moreover, in a case that the robot moves on the carpet, it may further determine the height of the carpet fiber, and then perform the obstacle avoidance in a case that the obstacle whose height is greater than the height of the carpet fiber is detected.

### BRIEF DESCRIPTION OF THE DRAWINGS

FIG. 1 is a flow chart of a carpet detection method and an obstacle avoidance method according to an embodiment of the present disclosure.

FIG. 2 is a schematic view showing a situation where plane scanning is performed by a robot according to an embodiment of the present disclosure.

FIG. 3 is another schematic view showing the situation where the plane scanning is performed by the robot according to an embodiment of the present disclosure.

FIG. 4 is a block diagram of the robot according to an embodiment of the present disclosure.

FIG. 5 is a flow chart of a carpet detection method according to an embodiment of the present disclosure.

### DETAILED DESCRIPTION OF THE EMBODIMENTS

In the following description, for the purpose of explanation rather than limitation, specific details, such as a particular system structure and techniques, are provided to facilitate the thorough understanding of the embodiments of the present disclosure. However, it should be appreciated that, the present disclosure may also be implemented in other embodiments without these specific details. In other cases, detailed description about well-known systems, devices, circuits and methods are omitted to avoid the description from being obscured by unnecessary details.

It should be appreciated that, the term “include/including” used in the embodiments of the present disclosure indicates the presence of the described features, entities, steps, operations, elements, and/or components, but does not exclude the presence or addition of one or more other features, entities, steps, operations, elements, components, and/or combinations thereof. It should be further appreciated that, the term “and/or” used in the embodiments of the present disclosure refers to any combination of one or more of the listed items and all possible combinations.

As used in the embodiments of the present disclosure, the term “if” may, depending on the context, be interpreted as “in a case that”, “once”, “in response to determining” or “in response to detecting”. Similarly, the expression “if it is determined” or “if [a described condition or event] is detected” may, depending on the context, be interpreted as “once it is determined”, “in response to determining”, “once [the described condition or event] is detected” or “in response to detecting [the described condition or event]”.

In addition, in the description in the embodiments of the present disclosure, such words as “first”, “second” and “third” are merely used to differentiate different components rather than to represent any importance. Such expressions as “one embodiment” and “some embodiments” intend to indicate that specific features, structures or characteristics are contained in at least one embodiment of the present disclosure. Hence, unless otherwise defined, the expressions such as “in one embodiment”, “in some embodiments” and “in some other embodiments” do not necessarily refer to the same embodiments but indicate “one or more, but not all, embodiments”. The terms “include”, “including” and the variations thereof mean “include but not limited to”, unless otherwise defined.

With the rapid development of cleaning robots that have both sweeping and mopping functions, carpet identification has become increasingly crucial. A robot needs to know a position of a carpet to formulate distinct cleaning strategies. For instance, in a mopping mode, the robot should avoid the carpet to prevent the carpet from being wet, while in a sweeping mode, the robot should avoid the carpet whose height is greater than a preset value to prevent a main brush or a side brush from being stuck. Currently, mainstream methods for carpet identification include ultrasonic identification and main brush current identification. However, these methods have such problems as a slow response, a low identification rate, and being unable to detect a length of a carpet fiber.

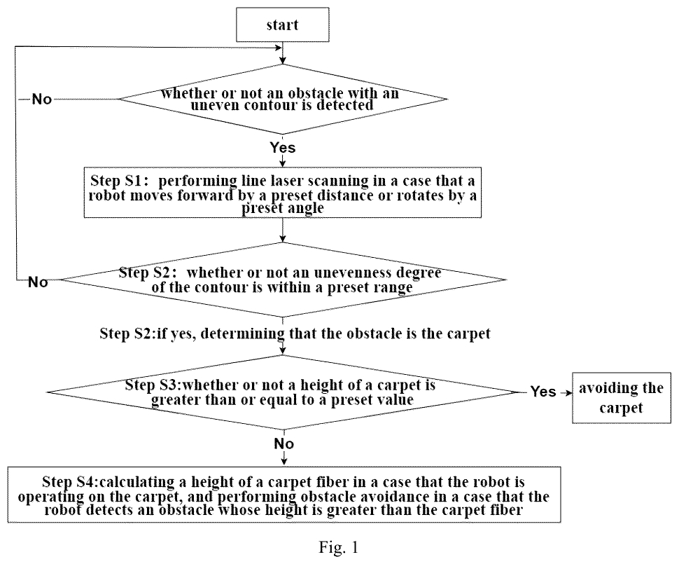

In order to solve the above-mentioned problems, the present disclosure provides in some embodiments a carpet detection method for a robot. A carpet is identified using a line laser sensor in real time. After an uneven contour is identified, the robot further performs plane scanning, and determines that an obstacle is the carpet in a case that a height difference between point clouds is within a preset range, so as to improve the identification accuracy. In addition, the detection is performed without a map and IMU data, resulting in a low computational burden and a rapid response. As shown in FIG. 1 and FIG. 5, the carpet detection method specifically includes the following steps.
Step S1: in a case that the obstacle with an uneven contour is detected by the robot, performing plane scanning based on data from the line laser sensor.
Step S2: in a case that an unevenness degree of the contour is within a preset range, determining that the obstacle is the carpet.

In an embodiment of the present disclosure, in Step S1, the detecting the obstacle with the uneven contour specifically includes: Step S11, generating, by the robot, a line laser and obtaining an image using an image sensor to obtain point cloud data; and Step S12, calculating heights of point clouds, and in a case that the heights of the point clouds are not the same, determining that the obstacle with the uneven contour is detected by the robot. In Step S11, the robot generates the line laser to detect an environment while moving forward. The image sensor collects an image formed by the line laser reflected by an object, so as to obtain the contour of the object and related point cloud data. A height change in a Z-axis of the object is represented as pixel movement in the image sensor, i.e., the contour reflects the height of the object. Hence, a height change of the point clouds reflects a change in the contour of the object. It should be appreciated that, the object with the uneven contour may be the carpet or any another obstacle, so it is required to further determine whether the object is the carpet to avoid misjudgment.

In a possible embodiment of the present disclosure, the height of the point cloud is calculated by the robot through point_r(x3, y3, z3)=ext(x1, y1, z1)*point_c(x2, y2, z2), where point_r(x3, y3, z3) represents coordinates of the point cloud relative to a center of the robot, ext(x1, y1, z1) represents coordinates of the line laser sensor relative to the center of the robot, point_c(x2, y2, z2) represents coordinates of the point cloud relative to the line laser sensor, and z3 represents the height of the point cloud. It should be appreciated that, ext(x1, y1, z1) is an extrinsic parameter of the line laser sensor determined in a case that the line laser sensor is installed on the robot, and point_c(x2, y2, z2) is directly obtained by the line laser sensor.

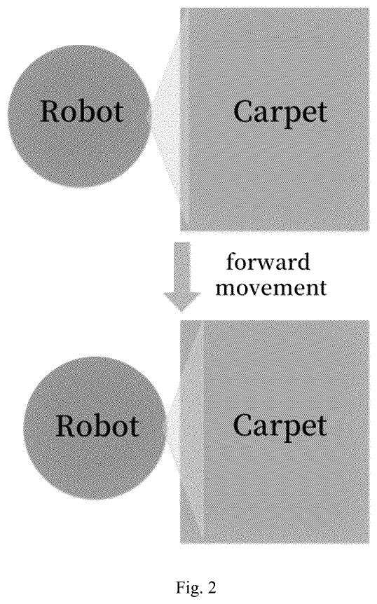

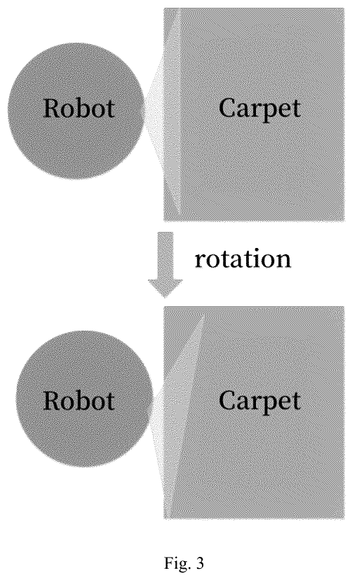

In a possible embodiment of the present disclosure, in Step S1, the performing the plane scanning specifically includes: generating, by the robot, a line laser, and scanning a plane in a case that the robot moves forward by a preset distance relative to the obstacle, or rotates to left or right by a preset angle; and obtaining, by the image sensor, an image to obtain the point cloud data of the obstacle within the plane. Further, in Step S2, the determining whether the obstacle is the carpet specifically includes: Step S21, calculating, by the robot, a height of each point cloud based on data obtained after the plane scanning; and Step S22, comparing the heights of every two point clouds, and in a case that a height difference between the two point clouds is within a preset range, determining that the obstacle is the carpet. In an embodiment of the present disclosure, as shown in FIG. 2, the robot moves forward by 5 cm to collect several frames of point cloud data. In a case that the heights of the point clouds are not the same but a height difference between every two point clouds is smaller than 3 mm, it means that the obstacle with the uneven contour is the carpet. In another embodiment of the present disclosure, as shown in FIG. 3, the robot rotates to the right by 30° to collect several frames of point cloud data. In a case that the heights of the point clouds are not the same but a height difference between every two point clouds is smaller than 3 mm, it means that the obstacle with the uneven contour is the carpet. It should be appreciated that, a height change of the carpet fiber is within a certain range, usually smaller than 1 cm, which is an empirical value and may be adjusted according to different carpet types. Generally, an obstacle with a too large height change is not carpet.

The present disclosure further provides in some embodiments an obstacle avoidance method. Referring to FIG. 1, the obstacle avoidance method includes the above-mentioned carpet detection method, and further includes: Step S3, calculating a height of a carpet based on data from a line laser sensor, in a case that the height of the carpet is greater than or equal to a preset height, avoiding the carpet, and in a case that the height of the carpet is less than the preset height, proceeding to Step S4; and Step S4, in a case that the robot is operating on the carpet, identifying and calculating a height of a carpet fiber, and in a case that an obstacle with a height greater than the height of the carpet fiber is detected, performing obstacle avoidance. The robot further detects the height of the carpet fiber, and performs the obstacle avoidance in a case that the robot has detected the obstacle whose height is greater than the height of the carpet.

It should be appreciated that, the carpet consists of a carpet pad and carpet fibers. The robot may only detect a height of the carpet pad (commonly referred to as the height of the carpet, i.e., the height of the carpet actually refers to the height of the carpet pad) in a case that the robot is located away from the carpet. The robot may detect the height of the carpet fiber only in a case that it moves onto the carpet.

In an embodiment of the present disclosure, in Step S4, the identifying the carpet fiber specifically includes: Step S41, in a case that an obstacle with an uneven contour is detected by the robot on the carpet, performing plane scanning based on data from the line laser sensor; and Step S42, in a case that an unevenness degree of the contour is within a preset range, determining that the obstacle is the carpet fiber based on data obtained after the plane scanning. A method for identifying the carpet fiber is the same as the above-mentioned method for identifying the carpet, and thus will not be particularly defined herein.

Based on the above, an average height of the point clouds obtained by the line laser sensor in Step S1 is calculated to obtain the height of the carpet (i.e., the height of the carpet pad). In a case that the robot moves on the carpet and the unevenness degree of the contour of the obstacle is within the preset range, the height of the point cloud obtained by the line laser sensor is calculated to obtain the height of the carpet fiber. In a case that the heights of some point clouds are obviously greater than the height of the carpet fiber, e.g., a height difference is greater than 1 cm, it means that there is the other obstacle on the carpet, and the robot needs to perform the obstacle avoidance. In a case that the contour of the object in front of the robot is flat, i.e., the heights of the point clouds are the same, it means that a flat ground surface is in front of the robot.

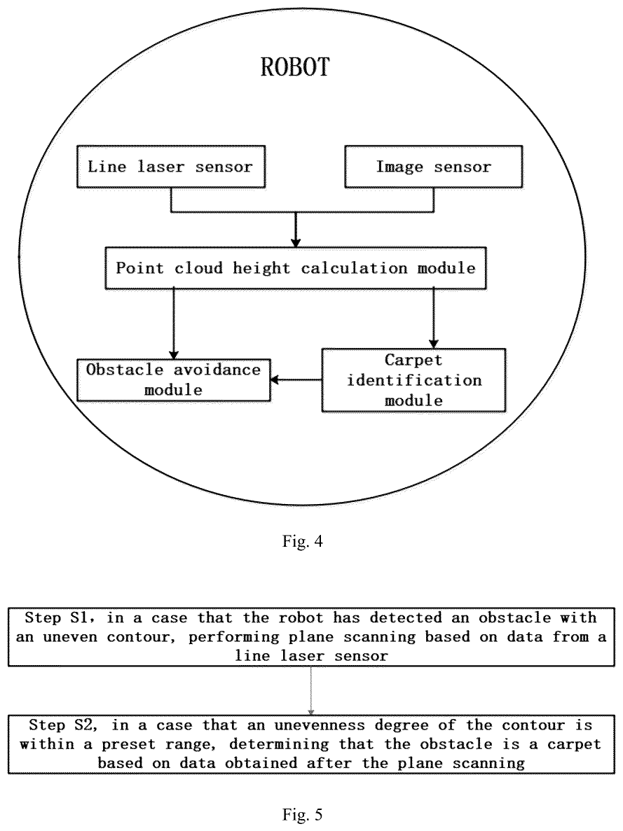

The present disclosure further provides in some embodiments a robot. As shown in FIG. 4, the robot includes: a line laser sensor configured to generate a line laser to detect an object; an image sensor configured to obtain a line laser image projected by the line laser sensor onto a surface of the object; a point cloud height calculation module, as a virtual module, configured to calculate a height of a point cloud based on the line laser image obtained by the image sensor; a carpet identification module, as a virtual module, configured to determine whether an obstacle is a carpet based on the height of the point cloud; and an obstacle avoidance module, as a virtual module, configured to perform obstacle avoidance based on a height of the carpet and a height of a carpet fiber. The robot is a cleaning robot, e.g., a household cleaning robot or a commercial cleaning robot. For example, the robot is a sweeping robot, a mopping robot, or a robot that have both sweeping and mopping functions.

It should be appreciated that, the detection of the environment using the line laser is an active optical measurement technique. A basic principle thereof includes projecting, by a structured light projector, a controllable light pattern onto a surface of a to-be-detected object, collecting, by an image sensor, an image, and calculating three-dimensional coordinates of the object using a mathematical model based on a geometric relationship. The image sensor is a special infrared camera sensor for obtaining an image only including laser lines, rather than an image obtained by a conventional camera.

In a possible embodiment of the present disclosure, the quantity of line laser sensors may be one or more, and the line laser sensor is arranged at such a position that the robot can detect an obstacle in front of the robot. In an embodiment of the present disclosure, one line laser sensor is arranged at a front surface of the robot with a scanning angle of 160°, and it may obtain one piece of point cloud data per degree, i.e., each frame includes 160 pieces of point cloud data. In addition, the line laser sensor has a frame rate of 30 fps, i.e., 30 frames, totally 4800 pieces of point cloud data, may be obtained per second.

The present disclosure further provides in some embodiments a chip storing therein a computer program code and arranged in the above-mentioned robot. The computer program code is executed to implement the steps of the above-mentioned carpet detection method or obstacle avoidance method. Alternatively, the computer program code is executed to achieve the functions of the virtual modules of the above-mentioned robot. For example, the computer program code may be divided into one or more modules, which are stored in the chip and executed by the chip to implement the present disclosure. The one or more modules may be a series of computer program instruction segments capable of achieving specific functions, and these instruction segments are used to describe execution processes of the computer program code within the robot. For instance, the computer program code may be divided into the point cloud height calculation module, the carpet identification module, and the obstacle avoidance module mentioned hereinabove. Through the chip, the carpet is identified using the line laser sensor in real time. After an uneven contour is identified, the robot further performs the plane scanning, and determines that the obstacle is the carpet in a case that a height difference between the point clouds is within a preset range, so as to improve the identification accuracy. In addition, the detection is performed without a map and IMU data, resulting in a low computational burden and a rapid response. Moreover, in a case that the robot moves on the carpet, it may further determine the height of the carpet fiber, and then perform the obstacle avoidance in a case that the obstacle whose height is greater than the height of the carpet fiber is detected.

It should be appreciated that, all or parts of the steps in the method may be implemented relevant hardware under the control of a computer program. The computer program may be stored in a non-volatile computer-readable storage medium, and when the computer program is executed, it includes the processes of the above-mentioned method. In addition, references to memory, storage, database or any other media may include a non-volatile memory and/or a volatile memory. The non-volatile memory may include read-only memory (ROM), programmable read-only memory (PROM), electrically programmable read-only memory (EPROM), electrically erasable programmable read-only memory (EEPROM), or flash memory. The volatile memory may include random access memory (RAM) or external cache memory.

The technical features in the embodiments of the present disclosure may be combined in any way. For clarification, not all possible combinations have been described in the embodiments of the present disclosure. However, these combinations shall also fall within the scope of the present disclosure in the case of no conflict.

The above embodiments are for illustrative purposes only, but shall not be construed as limiting the scope of the present disclosure. It should be appreciated that, a person skilled in the art may further make improvements and modifications without departing from the principle of the present disclosure, and these improvements and modifications shall also fall within the scope of the present disclosure.

What is claimed is:

1. A carpet detection method for a robot, comprising:
Step S1, in a case that the robot has detected an obstacle with an uneven contour, performing plane scanning based on data from a line laser sensor; and
Step S2, in a case that an unevenness degree of the contour is within a preset range, determining that the obstacle is a carpet based on data obtained after the plane scanning.

2. The carpet detection method according to claim 1, wherein in Step S1, the robot has detected an obstacle with an uneven contour comprises:
Step S11, generating, by the robot, a line laser, and obtaining an image using an image sensor to obtain point cloud data; and
Step S12, calculating heights of point clouds, and in a case that the heights of the point clouds are not the same, determining that the obstacle with the uneven contour is detected by the robot.

3. The carpet detection method according to claim 2, wherein the height of the point cloud is calculated by the robot through point_r(x3, y3, z3)=ext(x1, y1, z1)*point_c(x2, y2, z2), wherein point_r(x3, y3, z3) represents coordinates of the point cloud relative to a center of the robot, ext(x1, y1, z1) represents coordinates of the line laser sensor relative to the center of the robot, point_c(x2, y2, z2) represents coordinates of the point cloud relative to the line laser sensor, and z3 represents the height of the point cloud.

4. The carpet detection method according to claim 3, wherein in Step S1, the performing plane scanning comprises:
generating, by the robot, the line laser, and scanning a plane in a case that the robot moves forward by a preset distance relative to the obstacle, or rotates to left or right by a preset angle; and
obtaining, by the image sensor, an image to obtain the point cloud data of the obstacle within the plane.

5. The carpet detection method according to claim 4, wherein in Step S2, determining that the obstacle is a carpet comprises:
Step S21, calculating, by the robot, a height of each point cloud based on data obtained after the plane scanning; and
Step S22, comparing the heights of every two point clouds, and in a case that a height difference between the two point clouds is within a preset range, determining that the obstacle is the carpet.

6. An obstacle avoidance method, comprising the carpet detection method according to claim 1, and further comprising:
Step S3, calculating a height of a carpet based on data from the line laser sensor, in a case that the height of the carpet is greater than or equal to a preset height, avoiding the carpet, and in a case that the height of the carpet is less than the preset height, proceeding to Step S4; and
Step S4, in a case that the robot is operating on the carpet, identifying a height of a carpet fiber and calculating a height of the carpet fiber, and in a case that an obstacle with a height greater than the height of the carpet fiber is detected, performing obstacle avoidance.

7. The obstacle avoidance method according to claim 6, wherein in Step S4, the identifying the height of the carpet fiber comprises:
Step S41, in a case that the obstacle with an uneven contour is detected by the robot on the carpet, performing plane scanning based on the data from the line laser sensor; and
Step S42, in a case that an unevenness degree of the contour is within a preset range, determining that the obstacle is the carpet fiber based on data obtained after the plane scanning.

8. A robot for implementing the obstacle avoidance method according to claim 6, comprising:
a line laser sensor configured to generate a line laser to detect an object;
an image sensor configured to obtain a line laser image projected by the line laser sensor onto a surface of the object;
a point cloud height calculation module configured to calculate a height of a point cloud based on the line laser image obtained by the image sensor;
a carpet identification module configured to determine whether or not an obstacle is a carpet based on the height of the point cloud; and
an obstacle avoidance module configured to perform obstacle avoidance based on a height of the carpet and a height of a carpet fiber.

9. The robot according to claim 8, wherein a quantity of line laser sensors is one or more, and the line laser sensor is arranged at such a position that the robot detects the obstacle in front of the robot.

10. A chip storing therein a computer program code, wherein the computer program code is executed to implement the carpet detection method according to claim 1.

11. A chip storing therein a computer program code, wherein the computer program code is executed to implement the obstacle avoidance method according to claim 6.
